(19) United States
(12) Patent Application Publication
(10) Pub. No.: US 2007/0288961 A1
(43) Pub. Date: Dec. 13, 2007

(54) CHANNEL SELECTION BASED ON PROGRAM CONTENT ATTRIBUTES

(76) Inventors: RICHARD L. GULDI, Dallas, TX (US); Frank Dennis Poag, Plano, TX (US)

Correspondence Address: TEXAS INSTRUMENTS INCORPORATED, P O BOX 655474, M/S 3999, DALLAS, TX, 75265, US

(21) Appl. No.: 11/423,519

(22) Filed: Jun. 12, 2006

(51) Int. Cl. H04N 5/445; H04N 7/10; H04N 5/50; H04N 7/025

(52) U.S. Cl. 725/46; 725/38; 348/731; 725/34

(57) ABSTRACT

Methods and apparatus determine program content attribute(s) of channels or programs received by an audio/video receiver. Program content attributes are determined by extracting attribute tagging data transmitted on a channel, by looking up previously stored attributes for a channel in a program content attribute table, and/or by identifying content through automatic data processing of the received channel signals themselves. Attributes may include, for example, national language, conversation vs. music, type of conversation (sports, call-in talk show) or music (classical, jazz, rock 'n roll), etc. The determined program content attributes are compared with program content attribute preferences specified for one or more users to develop matches for channel listening/viewing selection. Manual or automatic user identification may be implemented, along with storage of individual program content attribute preferences of different users. By comparing program content attribute(s) in use on a given channel, with program content attribute preferences of the current user, a list of preferred channels is automatically generated.

This relates to apparatus and methods for selecting channels by an audio/video receiver based on user preferred attributes of the content of received programs.

### BACKGROUND

Modern program-delivery technologies have caused a proliferation of broadcast audio, video or audio and video (hereafter “audio/video”) programming. Such services or “channels” are now delivered via terrestrial broadcast stations, cable systems, satellite broadcasting, internet webcasting, and other means. One channel is differentiated from another by a unique carrier frequency within a band of frequencies, a unique data set within a multiplex of data (such as an MPEG transport stream or similar digital audio stream), or by means of other differentiating characteristics. With the rapid growth in the number of available channels has come the problem of determining how to quickly tune to channels with programs of interest (for example, those in a particular language or having other user preferred program content attributes), while skipping other channels not of interest.

A typical and useful feature in many multiple channel audio/visual receivers is the ability for a user to create a tailored list of preferred channels. The way this is done with programmable car radios and home TV sets, for example, is for the user to cycle through all of the available channels, listen to or watch each one long enough to decide whether he or she might be interested in its program content, then manually add that channel to (or omit that channel from) a list or subset grouping of preferred channels from which future individual channel selections can be made. Many broadcast systems, however, have a large number of channels from which selection can be made. For example, it is not uncommon for satellite radio, internet radio, and satellite or cable television systems to have well over 100 channels. So, manually determining which ones of all available channels might suit a particular user's tastes for program content attributes can take a lot of time. It would, therefore, be useful to be able to automatically develop such a subset, allowing users to be able to quickly tune in to one of the subset of channels with preferred attributes, without having to scan through a whole list of channels not having those attributes.

One important example of a program content attribute used to decide which channel to select is the national language (English, Spanish, French, German, etc.) used in the program content on a channel. Many users prefer to listen to or watch programs whose content is in their own native language or tongue or, at least, in another language that they understand. They would rather skip programs whose content is in another foreign language. It would, therefore, also be useful to be able to automatically determine the nationality of the language content used in programming on particular channels and to automatically develop a subset of channels whose program content is in one or more particular national languages. Such subset could be used to provide a group of channels from which selections could be made directly, or could be used as a starting point for development of a smaller subset applying other program content attributes of interest in addition to national language used (as, for example, a subset comprising a listing of channels featuring talk shows in the Spanish language).

Many known systems exist for electronic translation from one language to another. Some have text data as input, and provide text data in another language as output. Other systems, such as described in U.S. Pat. Nos. 6,157,727 and 6,243,669, translate audible speech in one language to audible speech in another. Such translation systems tend, however, to be complex due to a requirement first for voice recognition of the first language, then for voice-to-text conversion within the first language, then for text-to-text conversion from the first to a second language using associated text dictionaries, and finally for text-to-voice conversion in the second language. U.S. Pat. No. 6,704,698 teaches a method of identifying the language of a text document. It would be useful to be able to use such language translation and other language identification techniques, to be able to identify program content language for developing subsets of channels having user preferred attributes.

Programming on many cable television, satellite television, and satellite radio systems is tagged with data denoting channel attributes, typically on a channel-by-channel basis, or even on a program-by-program basis within a single channel. Such tagging may indicate program title, artist or actors, duration, parental rating level, service package or tier to which the program belongs, decryption keys, and/or language used (for example, Channel 181 is tagged as “Hispanic Talk” on Sirius satellite radio), among other attributes. Channel tagging is more likely found on channels or programs which are offered at a cost, as the tagging aids in control of access to the channel or program. Often the tags used by a multiple channel system are in a proprietary format or protocol, which may be unknown to those designing a system for determining program attribute used. It would be useful to be able to use such tagging data, when available, to be able to identify channel content attributes for developing subsets of channels having user preferred ones of the attributes.

### SUMMARY

This application describes methods and apparatus for electronically determining program content attributes in use on each of multiple channels received by an audio and/or video receiver; for accepting input of and optionally storing program content attribute preferences of one or more users; for identifying, either manually or automatically, the current user from multiple possible users; and for generating a list of those channels having the program content attributes preferred by the current user.

In an example embodiment, a program content attribute recognition subsystem (PARS) determines program content attributes used on each channel, and generates a local channel-to-program content attribute linkage table. Determination of program content attributes on each channel may be done electronically in one or more of a variety of ways, such as, for example, 1) by examining tagging data, if present and understood, on the channel; 2) by looking up program content attribute data from a pre-stored table of broadcast stations, their locations, and program content attributes used, augmented by position awareness from a global positioning system (GPS) receiver or other locating device; and/or 3) by electronically analyzing the audio present on the channel for characteristics of certain program content attributes.

A user identification and preference subsystem (UIPS) electronically determines which one of multiple users is currently using the receiver, and retrieves a pre-stored table of that user's program content attribute preferences. The UIPS also allows manual input of specific or generic user preferences.

The complexity of the UIPS implementation can differ according to the application. For example, the UIPS in an automobile might use weight, height, voice, seat position, and/or other sensors to automatically identify a current user from a known set of users. Alternatively, a lower cost system might use manual input to identify the user as, for example, through user specific identifying data entered on a keypad, through actuation of a control knob, via a fingerprint sensor, or through some other direct input mechanism.

In an example embodiment, the UIPS also contains a table of program content attribute preferences for each user. These preferences may be manually input by each user, or may be learned by the UIPS by noting which channels (and hence what program attributes) are selected by each user. User preferences may alternatively be stored on a non-volatile and removable memory mechanism, which is advantageous for applications where it is impractical to store in the receiver a large number of users' preferences, as, for example, in a receiver of a rental automobile. Manual input of generic user type (for example, Spanish speaker) may also be also supported.

In an example embodiment, when channel attributes and current user are known, those channels having a program content attribute matching one or more of the user preferred program content attributes are placed in a preferred channel table. A logical connection between the receiver and this preferred channel table then allows those preferred channels to be made available to the current user, while suppressing those non-preferred channels, for example, during channel scan.

While language is one key program content attribute, other attributes not as obvious may also be identified and used for determining channel preferences. For example, channels offering primarily music are differentiable from channels offering primarily news; “talk radio” has a significantly different sonic signature than music; classical music a different sonic signature than rock music; sporting events yet another sonic signature, and so forth.

Other benefits and advantages will be apparent to those skilled in the art.

### BRIEF DESCRIPTION OF THE DRAWINGS

Example embodiments are described with reference to accompanying drawings, wherein:

FIG. 1 is a block diagram of an example implementation of a system for automatically selecting channels in an audio/video receiver, based on user preferences for program content attributes of available multiple channels or programs;

FIG. 2 is a block diagram of an example implementation of a program content attribute recognition subsystem usable with a system, such as that shown in FIG. 1;

FIG. 3 is a block diagram of an example implementation of a user identification and preference subsystem usable with a system, such as that shown in FIG. 1; and

FIG. 4 is a block diagram illustrating an example of shared usage among multiple users of common components for channel selection based on user identification and user defined preferences for program content attributes.

Throughout the drawings, like elements are referred to by like numerals.

### DETAILED DESCRIPTION OF EXAMPLE EMBODIMENTS

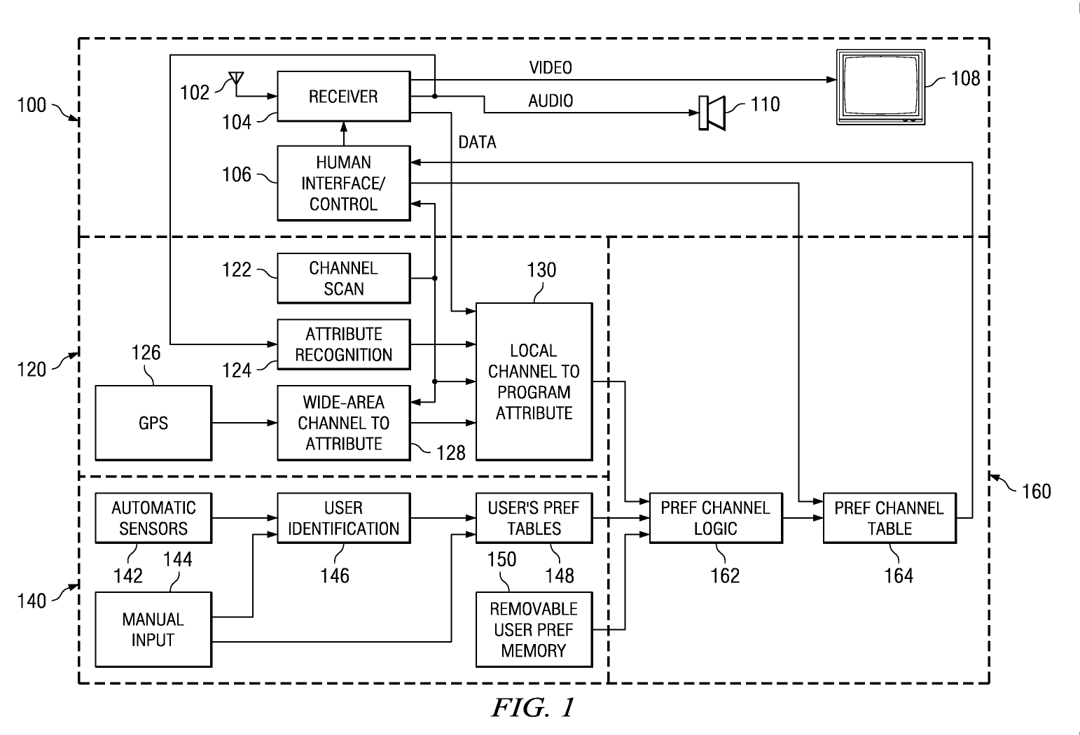

FIG. 1 shows an example embodiment of apparatus for selecting audio/video channels based on user chosen program content attributes, in accordance with principles of the invention. In the illustrated implementation, an audio/video receiver system 100 has a receiver 104 that receives multiple available channels of audio/video program transmission signals from a signal input, such as an antenna 102. A receiver control, shown by human interface/control 106, responds to inputs from a user via knobs, keypad, remote control, or other input device, and sends corresponding operating parameter control signals to receiver 104. Those operating parameter inputs may include channel selection (as, for example, carrier frequency selection for AM or FM broadcast transmissions or channel number selection for multiplexed digital radio transmission streams), sound volume level selection, on/off switch settings, and so forth. The audio output from receiver 104 may be set to drive an audio speaker 110 and the video output (if present) may be set to drive a video display 108.

Electronics for assisting the selection of channels or programs based on user preferences for program content attributes of available channels includes a program content attribute recognition subsystem 120, a user identification and preference subsystem 140, and a preferred channel logic subsystem 160. The program content attribute recognition system 120 electronically determines one or more program content attributes being used on each channel, compares the determined program content attribute(s) with program content attribute preferences associated with the current user, and creates a table of a subset of available having the attributes preferred by that user. To accommodate more than one user and differing preferences, multiple user preference tables are stored. Manual or automatic identification of the current user determines which user preference table to use at a given time.

Various approaches can be used for determining program content attributes used on each channel. Three of them are described by way of illustration for implementation, either singly or in combination, in the example embodiment. However, those skilled in the art to which the invention relates will appreciate that others may be used in place of, or in addition, to those described.

A first approach uses tagging data, if any, available on the received channel transmissions. Such tagging data may be carried in unused portions of time or frequency spectrums of received analog signals, or may be part of the data protocol of received digital signals. The use of tagging data is straightforward but such data, as already indicated, may not always be available or decipherable. As noted, only some programs are tagged as to program content attribute(s), and many of those are tagged in a proprietary and/or encrypted data format. However, if program content attribute tagging data is available and understandable, it may be made available as output from receiver 104 while the receiver is tuned to a particular channel, and stored together with its corresponding channel number, as an entry in a local channel-to-program content attribute table 130. For example, if received programs are tagged by type of music (“Rock,” “Jazz,” “Classical,” etc.), a table of channel number-to-type of music can be developed as table 130.

A second approach that may be used for determining program content attributes of channels uses a prestored table of channel-to-program content attribute data that is separately developed from known information about transmitted programs. For example, such tables can be developed independently and made available for initial storage and periodic updating on the system from private or public data available about descriptions of the content and/or characteristics of respective channels or upcoming programs for television and radio. Because different channel numbering may be used for the same channels, or the same channel numbering may be used for different channels, in different parts of a wide geographic area, tables can be developed of channel numbers, program content attribute(s) used and applicable geographic locations within the wide area. For example, some areas of the world, such as Europe, have many different countries with broadcast stations (e.g., AM and FM radio) using different national languages in close proximity. So, important program content attributes like national language may vary very quickly, depending on specific geographic location of the receiver. A receiver designed for use in such an area may, thus, be loaded with a wide-area channel-to-attribute table 128 having channel number (or frequency), geographical coordinates, and program content attribute(s) used for all broadcast stations in the wide area. Because of frequency reuse from local area to local area, this wide area table may have multiple stations and program content attributes linked to the same channel number. For example, different stations both using FM channel 20 may use French in France and Italian in Italy. Satellite delivery systems also employ frequency reuse through use of directional broadcast antennas. Such antennas allow distinctive geographic coverage footprints, with enough isolation from area to area to allow reuse of valuable satellite frequencies.

To further address the channel reuse issue, a GPS receiver 126 or other automatic geographic location identification system can be added to provide refinement of the channel/program content attribute knowledge. Program content attribute versus channel data from only those stations near enough to be received is then copied from wide-area channel-to-attribute table 128 to local channel-to-program attribute table 130. This refinement based on geographic location removes the uncertainty of attributes due to duplication of channels in the table.

A third approach analyzes the audio content of each channel to determine the program content attribute(s) in use. A channel scan circuit 122 may, for example, be included to periodically or occasionally successively tune in to each available channel by requesting tuning to the channel by the receiver control 106. Because the same receiver 104 may be used for tuning the desired channel during normal operation, channel scan 122 may be configured to run through the channel-by-channel tuning cycle at a time when the receiver 104 is not otherwise in use. The tuner may be successively tuned to each channel, and the audio content of the respective channel applied to and analyzed by an attribute recognition circuit 124 to determine the program content attribute(s) in use.

The use of one or more of these three approaches results in the development and storage of a local channel-to-program attribute table 130 of program content attribute data associated with particular channels for each of multiple receivable channels in a given area. Because particular channels may utilize different program content attributes at different times, some channels may have more than one associated program content attribute stored in the table. In such case, the table can be developed and utilized in conjunction with a system clock, so that attributes can be identified and selections made based on time of day.

In the illustrated example, a user identification and preference subsystem 140 is provided that utilizes a manual input 144 and/or automatic sensors 142 to differentiate and identify a particular user from among multiple possible users. For example, different family members may drive the same car or use the same television, and may have different program content attribute preferences. Automatic sensors 142 may, for example, include height, weight, voice, seat position, or other personal identification data sensors to generate a data set unique to each user. Automatic sensing may not be practical or cost effective in all applications. User identification may, alternatively or additionally, be done through manual entry via the manual input 144, using, for example, a keypad, knob, fingerprint identification or other manual or biometric entry sensor. User identification comparator 146 compares sensed and/or manually input user personal identification data with previously stored personal identification data for each user, thus identifying the current user. User preference tables 148 contain program content attribute preferences for each user. These preferences are typically manually input or chosen from menu items by each user using the manual input unit 144. Default user preferences can also be predefined, allowing, for example, a rental car user to quickly and manually input content attribute preferences, or allow the rental car company to pre-program the same. The user identification data from user identification comparator 146 is input to user preference tables 148, causing the output of data indicating the preferred program content attributes for the identified current user.

In the illustrated example, a preferred channel logic subsystem 160 is provided that has two inputs. The first input is the program content attribute data for available channels, which is received from the local channel-to-program attribute table 130. The second input is data on the program content attribute(s) preferred by the current user, which is received from the users preference tables 148. The preferred channel logic 162 compares the known or derived program content attribute(s) for each channel with the current user's chosen preferred program content attribute(s), and places the channel number for a particular channel into the preferred channel table 164 if the program content attribute(s) from table 130 match(es) the user's chosen preferred program attribute(s). The preferred channel table is then made logically available (as a designated preferred channel or subset of channels) to the receiver control 106 to facilitate selection of preferred channels or skipping of non-preferred channels.

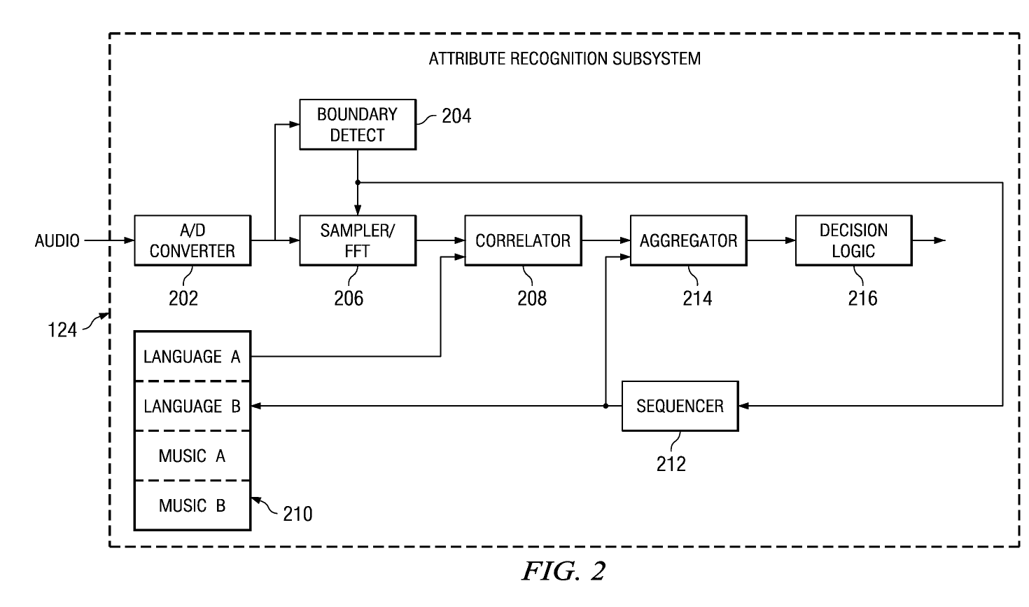

FIG. 2 shows in greater detail an example implementation for the attribute recognition subsystem 124 of FIG. 1, configured to determine program content attributes of a received broadcast channel or program, by analyzing the audio content of the received signal. This method of program content attribute recognition requires no tagging data or database of area/station/program content attribute links, so is therefore more universal.

The audio signal from receiver 104 is input to the audio input of attribute recognition subsystem 124. Here the audio signal is analyzed, using digital signal processing (DSP) techniques, to determine the program content attribute(s) in use. Each channel is typically tuned and examined as a background process during times the receiver is not otherwise being used. The program content attribute recognition may be done either with dedicated electronic circuitry, typically in an integrated circuit, or by software routines running on a digital signal processor (DSP) or general purpose computer such as a personal computer (PC).

Analog audio from receiver 104 is digitized by analog-to-digital (A/D) converter 202. Alternatively, digital audio from the receiver, if available, may be used directly. Boundary detect 204 examines in real time the digitized audio, and determines natural breaks between words and/or phonemes or other components of speech. Each portion of speech or other audio, between such detected boundaries, is examined by a sampler/FFT (Fast Fourier Transform ) element 206 for attributes such as frequency, duration of frequencies, number of unique frequencies, and other key parameters. These parameters are chosen such that there is wide variation in them as differing program attributes are input to the PARS. Once these unique characteristics are determined for a given sound sample, the data describing the characteristics is input to correlator 208. The second input of correlator 208 comes from a pre-stored table 210 of key identifying sound characteristics for each of multiple program content attributes. The example attributes shown in table 210 are multiple languages and multiple music types, but may include data representative of other attributes. To facilitate the addition of new program content attributes, or revision of existing program content attribute identifying characteristics, table 210 may be contained in a user-replaceable non-volatile read-only or random-access memory.

For each sample, sequencer 212 rapidly steps through each entry in table 210, which holds distinctive identifying characteristics for each program content attribute. These characteristics are chosen to be those which occur often in each program content attribute, and are formatted to match those characteristics output by sampler/FFT 206 given the same sound sample. As sequencer 212 steps through each entry in table 210, correlator 208 outputs a strong correlation signal for each sample from 206, matching one or more stored samples in 210. The range of address values in table 210 for each program content attribute is well defined, for example program content attribute A samples are stored from address 0 to address X. Aggregator 214 has as inputs both the correlator output and the sequencer address. At the end of each pass through the address range covering the entire table 210, aggregator 214 has a numerical value of correlation hits in each of the plurality of program content attribute address ranges. One of these correlation values will typically be significantly greater than the rest, and so will indicate the program content attribute being received. Decision logic 216 further refines the determination of program content attribute based on outputs of aggregator 214, and outputs a high-probability decision as to program content attribute in use on the tuned channel.

Those skilled in the art to which the invention relates will appreciate that other methods may be employed for electronically determining program content attributes based on analyzing the audio signal of speech or music.

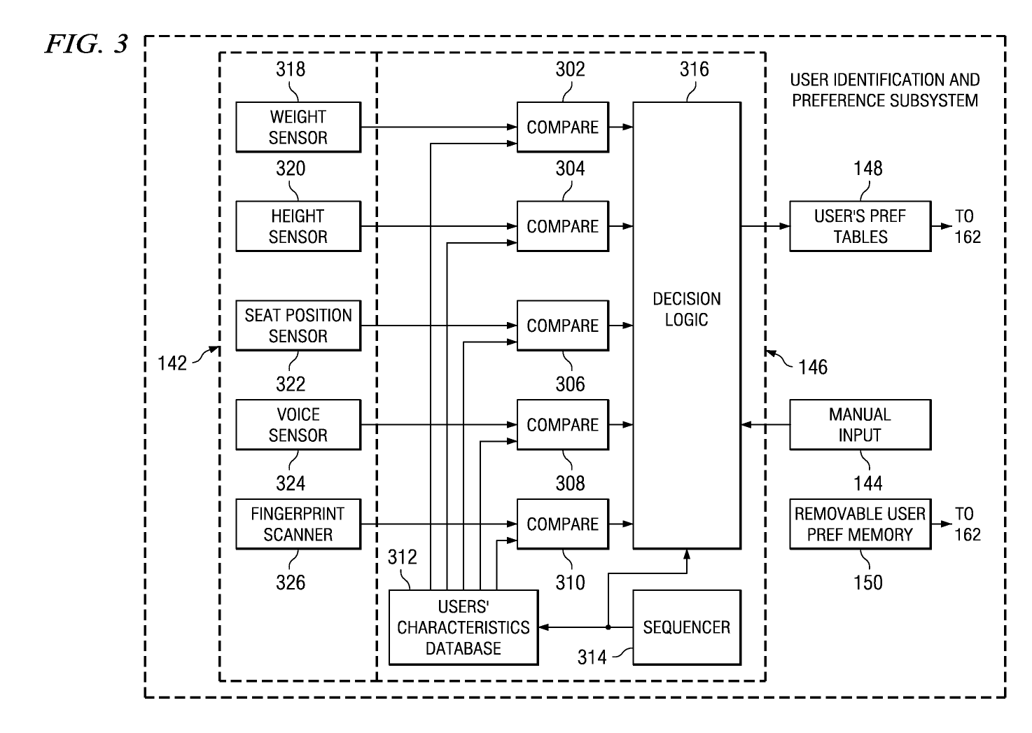

FIG. 3 is a block diagram of a UIPS as typically optimized for automotive use. As previously described, the UIPS determines which one of multiple users is currently using the receiver, and recalls that user's stored preferences for comparison with attributes of a channel tuned or to be tuned.

Multiple electronic or electromechanical sensors, such as weight sensor 318, height sensor 320, seat position sensor 322, voice sensor 324, and/or fingerprint scanner 326, measure one or more personal identification characteristics of the user. Each of these characteristics, typically represented as a digital value, is input to the first input of a group of comparators 302 through 310. The second input of each comparator has a driven connection with a users' characteristics database 312, which has been previously loaded with appropriate identifying characteristics for each user. When a user is sensed, outputs are generated by some or all of sensors 318-326. Sequencer 314 steps through users' characteristics database 312, presenting in turn to the comparators 302 through 310 a set of identifying characteristics for each user. Each comparator outputs a value indicative of the correlation between the sensed value and the stored value for each user and each sensed parameter. Decision logic 316 sums the outputs of all comparators, and also has as an input the output of sequencer 314. At one sequencer value representative of a unique user, the summation of comparator values will peak, identifying that user as the current user.

Manual entry of the current user identity is also supported through manual input 144. Selection of current user from a list of users is handled in one of many known ways such as scrolling through a list and pressing an enter key when the current user name is highlighted. This entry point can also accept current user identification from alternate existing sources, such as, for example, from a key fob which uniquely identifies a driver to the existing automotive electronics. Manual entry of generic user identity (for example, Spanish-speaking rental car customer)may also be done by manual input 144.

Once the current user identity is known, it is input to users' preference table 148. User preferences for each user have been manually stored in users' preference table 148, typically using the same human interface as used for input to the users' characteristics database 312.

The output of users' preference table 148 is thus the program content attribute(s) preferred by the current user, which is then input to preference channel logic 162, as previously described. Alternatively, user preference data is provided by a removable user preference memory 150, typically a non-volatile memory device storing the preferences distinctively associated with a given user.

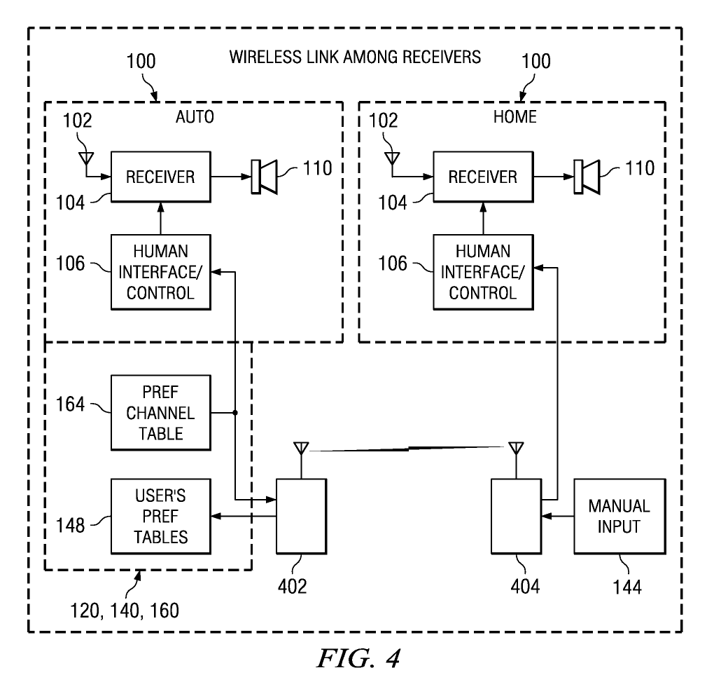

FIG. 4 shows an optional wireless data link between two receivers having a common user or users, for example an automotive receiver and a receiver in a nearby home. It is desirable that the home receiver or receivers have the same program content attribute selectable electronics functionality as the receiver in the automobile, but at less cost and complexity.

The automobile receiver (100—auto) is connected to a program content attribute selectable electronics system comprising a program content attribute recognition subsystem (PARS) 120, a user identification and preference subsystem (UIPS) 140, and a preferred channel logic subsystem (PCLS) 160 as previously described. For simplicity, FIG. 4, however, shows only those functional blocks—preference channel table 164 and users' preference tables 148—that interface to the wireless data link. Although not shown in FIG. 4, the other functional blocks of the program content attribute recognition subsystem 120 are also present in the automobile receiver.

A home receiver 100 HOME may have the same functional characteristics as the automobile receiver 100 AUTO. The given example implementation does not, however, provide a separate program content attribute recognition subsystem 120 system connected directly with receiver 100 HOME. Instead, a wireless data link is provided between the two receivers by data transceivers 402 and 404. This bidirectional link enables the home receiver 100 HOME to share the program content attribute recognition subsystem 120 system of automobile receiver 100 AUTO.

The user of the home receiver 100 HOME will typically input his/her identification through manual input device 144. The user identity will then be transmitted by transceiver 404 in the home to transceiver 402 in the auto. The user identity is then passed to users' preference tables 148 in the program content attribute recognition subsystem 120.

Operating as previously described, the program content attribute recognition subsystem 120 in the automobile receiver 100 AUTO develops (or has developed through prior use) a preference channel table 164 for the current user at the current location. The location of the two receivers may be generally identical—that is, the same stations or channels are receivable by both. This preferred channel data is input to transceiver 402 and sent to transceiver 404. On receipt by transceiver 404, the preferred channel data of the identified current user is passed to the human interface/control 106 of the home receiver 100 HOME. Having this preferred channel data, the home receiver 100 HOME then tunes only those channels desired by the current user, and skips undesired channels. If human interface/control 106 of 100 HOME has sufficient memory, the most recent preferred channel data for each user is stored. This provides the continuing benefit of per-user preferences, even when communication with the receiver 100 AUTO is lost (for example, caused by another family member driving off in the automobile having the program content attribute recognition subsystem 120 system). In the absence of data from the program content attribute recognition subsystem 120 in 100 AUTO, user input of identification to manual input 144 causes the retrieval by human interface/control 106 of his most recent preference data, with a message indicating loss of real-time data. One skilled in the art will appreciate that alternative synchronization routines may be used to prevent or otherwise handle such data loss.

The cost and complexity of a short-range wireless data link may be lower than the program content attribute recognition subsystem 120 system. A wireless link among multiple receivers and a common program content attribute recognition subsystem 120 system can therefore make the benefits of program content attribute recognition subsystem 120 available to multiple receivers at lower cost.

It will be appreciated that a variety of alternative wireless data communication systems may be suitable for the described link. The program content attribute recognition subsystem 120 system could also be interconnected with a receiver other than the automobile receiver, while retaining the described advantages. Automatic identification of user at locations remote from the program content attribute recognition subsystem 120 may also be implemented, if desired.

Those skilled in the art to which the invention relates will appreciate that some of the functions described above with reference to different reference numerals in the drawings can be performed by separate elements, by common elements performing multiple ones of the functions, or by programming of a microprocessor, digital signal processor, or the like. Moreover, it will be appreciated that the described tables and related functions may be implemented by look-up tables stored in one or more memories accessed via programming of the same or a different processor, or may be implemented using other digital or analog circuitry. Those skilled in the art to which the invention relates will further appreciate that other combinations, substitutions, modifications, and additions or deletions may be made in or to the described embodiments, without departing from the spirit and scope of the claimed invention.

What is claimed is:

1. A method for aiding user selection of one or more channels from among multiple audio or video program channels based upon programming content of programs transmitted on the channels, comprising:
receiving, with a receiver, respective signals of programs transmitted on the multiple channels;
selecting, with a controller coupled to the receiver, one of the multiple channels for presentation of a program to a user; and
identifying, with electronics coupled to the receiver and controller, channels available for selection whose transmitted programs have program content attributes that match predesignated program content attributes.

2. The method of claim 1, wherein the identifying step further comprises analyzing the respective received program signals for identifying channels having the predesignated program content attributes, and generating a subset of channels available for selection by the controller.

3. The method of claim 2, wherein the identifying step further comprises analyzing respective transmitted program audio signals using a digital signal processor for identifying the channels having the predesignated program content attributes.

4. The method of claim 2, wherein the identifying step further comprises identifying channels having program content attributes associated with program broadcasts in a given national language.

5. The method of claim 2, wherein the identifying step further comprises identifying channels having program content attributes associated with music or talk program broadcasts of a given type of music or talk.

6. The method of claim 2, further comprising storing program content attribute preferences of one or more users; and specifying the predesignated program content based on identification of a current user.

7. The method of claim 6, further comprising sensing user characteristics, and identifying the current user based on a comparison of the sensed user characteristics with prestored user characteristics.

8. The method of claim 7, wherein the sensed user characteristics comprise physical characteristics, including at one or more of weight, height, or fingerprint.

9. The method of claim 6, further comprising storing listings of channels available for selection whose transmitted programs have program content attributes that match predesignated program content attribute preferences respectively associated with one or more users; and specifying a listing of channels available for selection based on identification of a current user.

10. The method of claim 1, wherein the identifying step further comprises identifying channels having the predesignated program content attributes responsive to tagging data received with the respective signals and indicative of program content attributes of the transmitted programs.

11. The method of claim 1, wherein the identifying step further comprises identifying channels having the predesignated program content attributes based on a table of program content attributes associated with respective ones of the channels.

12. The method of claim 11, further comprising determining a location with a GPS location identifying element; and wherein the identifying step further comprises identifying channels having the predesignated program content attributes based on a table of program content attributes associated with respective ones of the channels for locations determined by the GPS location identification element.

13. Apparatus for aiding user selection of one or more channels from among multiple audio or video program channels based upon programming content of programs transmitted on the channels, comprising:
a receiver for receiving respective signals of programs transmitted on the multiple channels;
a controller coupled to the receiver for selecting one of the multiple channels for presentation of a program to a user; and
electronics coupled to the receiver and controller for identifying channels available for selection whose transmitted programs have program content attributes that match predesignated program content attributes.

14. The apparatus of claim 13, wherein the electronics comprises a program attribute recognition subsystem adapted and configured for analyzing the respective received program signals, for identifying channels having the predesignated program content attributes, and for generating a subset of channels available for selection by the controller.

15. The apparatus of claim 14, wherein the program attribute recognition subsystem further comprises a digital signal processor adapted and configured for analyzing respective transmitted program audio signals for identifying the channels having the predesignated program content attributes.

16. The apparatus of claim 14, wherein the program attribute recognition subsystem is adapted and configured for identifying channels having program content attributes associated with program broadcasts in a given national language.

17. The apparatus of claim 14, wherein the program attribute recognition subsystem is adapted and configured for identifying channels having program content attributes associated with music or talk program broadcasts of a given type of music or talk.

18. The apparatus of claim 14, further comprising a user identification and preference subsystem adapted and configured for storing program content attribute preferences of one or more users; and for specifying the predesignated program content based on identification of a current user.

19. The apparatus of claim 18, wherein the user identification and preference subsystem further comprises one or more sensors for sensing user characteristics, and is further adapted and configured for identifying the current user based on a comparison of the sensed user characteristics with prestored user characteristics.

20. The apparatus of claim 19, wherein the user characteristics comprise physical characteristics, including at one or more of weight, height, or fingerprint.

21. The apparatus of claim 18, further comprising a user identification and preference subsystem adapted and configured for storing listings of channels available for selection whose transmitted programs have program content attributes that match predesignated program content attribute preferences respectively associated with one or more users; and for specifying a listing of channels available for selection based on identification of a current user.

22. The apparatus of claim 13, wherein the program attribute recognition subsystem is further adapted and configured for identifying channels having the predesignated program content attributes responsive to tagging data received with the respective signals and indicative of program content attributes of the transmitted programs.

23. The apparatus of claim 13, wherein the program attribute recognition subsystem is further adapted and configured for identifying channels having the predesignated program content attributes based on a table of program content attributes associated with respective ones of the channels.

24. The apparatus of claim 23, further comprising a GPS location identification element and wherein the program attribute recognition subsystem is further adapted and configured for identifying channels having the predesignated program content attributes based on a table of program content attributes associated with respective ones of the channels for locations determined by the GPS location identification element.
